(19) United States
(12) Patent Application Publication
(10) Pub. No.: US 2025/0079044 A1
(43) Pub. Date: Mar. 6, 2025

(54) CORE WIRE SET AND TRANSMISSION CABLE THEREOF

(71) Applicant: ELKA INTERNATIONAL LTD., New Taipei City (TW)

(72) Inventor: Jui-Ming YANG, New Taipei City (TW)

(73) Assignee: ELKA INTERNATIONAL LTD., New Taipei City (TW)

(21) Appl. No.: 18/588,239

(22) Filed: Feb. 27, 2024

(30) Foreign Application Priority Data
Aug. 29, 2023 (TW) 112209223

(51) Int. Cl. H01B 7/42; H01B 7/00

(52) U.S. Cl. CPC H01B 7/428; H01B 7/0009

(57) ABSTRACT

A core wire set comprising a first core wire, a second core wire arranged in parallel to the first core wire, a first covering layer covering the first core wire and the second core wire, a second covering layer, and a bare metal wire is provided. Wherein the second covering layer covers the first covering layer and a wire placement space is formed between the first covering layer and the second covering layer. Wherein the bare metal wire is arranged in the wire placement space.

### FIELD OF THE INVENTION

The disclosure relates to a core wire set for a transmission cable, particularly a core wire set with a bare metal wire and core wires for transmission.

### BACKGROUND OF THE INVENTION

With the progress of technologies for transmission cables and connectors, the number of pins in a single connector is increasing, and correspondingly, the number of core wires arranged in a transmission cable is also increasing. To prevent the overall diameter of a transmission cable from being too large or its hardness from being too hard, making it difficult for the user to use or set up flexibly, the core wires arranged in a transmission cable have been developed towards miniaturization of the wire diameter or softening of the material. However, due to the required increase to increase product yield in machining precision effectively, the manufacturing difficulty of miniaturized and highly integrated transmission connectors and transmission cables had significantly increased, making it challenging to increase product yield effectively.

For example, the core wire(s) arranged in a transmission cable is (are) bonded to the soldering pad on the circuit board of the transmission connector by welding or other means. The welding parameters (such as welding time or welding temperature) and the accuracy of welding parameters for the process will affect the product's manufacturing yield. However, the insulation layer of wires with a small diameter may be easily burned through or shrunk due to improper welding temperature or time control during welding. The burned-through or shrunk insulation layer may cause shorting between the core wire inside the burned-through or shrunk insulation layer and the surrounding conductors (such as other core wires, grounding conductors, or drain wires) or open circuits in the core wire itself.

More specifically, in the instance of a core wire set with a bare metal wire as the drain wire, the core wire set may have more than two transmission core wires and at least one bare metal wire as a drain wire, wherein the transmission core wires and the bare metal wire are covered with a covering layer. Before welding, the insulation layer of the transmission core wires is partially peeled off (usually the front-end part of the insulation layer). Then, the wires are arranged in sequence to their welding positions using a welding bracket for welding. Welding parameters such as welding temperature or time are not adequately controlled; the welding process may shrink the transmission core wire's remaining insulation layer (kept intact for insulation purposes) because of damage or melting caused by excessive temperature during welding. On the other hand, the bare metal wire used as the drain wire during welding will also be heated because of the welding, and the heat received by the bare metal wire during welding will also be transmitted to the insulation layer of the transmission core wire. When the welding temperature control is poor, the heat received by the bare metal wire during welding will cause perforation or damage to the insulation layer of the transmission core wire, and then the bare metal wire may be in contact with the conducting part of the transmission core wire. The damage or shrinkage of the insulation layer of the transmission core wire may cause shorting between the transmission core wire and the surrounding conductors and result in the failure of welding. Accordingly, the yield rate of welded products may decrease, and a low yield rate leads to a waste of resources and is time-consuming because of rework.

To prevent the situation mentioned above, the manufacturer needs to repeatedly try to correct the welding parameters or directly use high-precision welding equipment for welding, which indirectly requires additional time for development and costs for production.

### SUMMARY OF THE INVENTION

The disclosure provides a core wire set for a transmission cable that decreases the risk of damaging the core wires during welding.

One of the purposes of the disclosure is to provide a core wire set for a transmission cable that prevents damage to the insulation layer of the transmission core wires caused by the heat from the bare metal wire.

In an embedment, a core wire set comprises a first core wire, a second core wire arranged in parallel to the first core wire, a first covering layer covering the first core wire and the second core wire, a second covering layer, and a bare metal wire. Wherein the second covering layer covers the first covering layer, and a wire placement space is formed between the first covering layer and the second covering layer. Wherein the bare metal wire is arranged in the wire placement space.

In an embedment, a transmission cable comprises a core wire set, and an outer insulation layer covers the core wire set. The core wire set comprises a first core wire, a second core wire arranged in parallel to the first core wire, a first covering layer covering the first core wire, and the second core wire, a second covering layer, and a bare metal wire. Wherein the second covering layer covers the first covering layer, and a wire placement space is formed between the first and second covering layers. Wherein the bare metal wire is arranged in the wire placement space.

In an embedment, the cross-section of the core wire set, the center of the first core wire, the center of the second core wire, and the center of the bare metal are arranged in a triangular shape.

In an embedment, wherein the first covering layer's first side faces the first core wire, and the second core wire is insulated.

In an embedment, wherein a second side of the first covering layer is opposite to the first core wire and the second core wire is conducting.

In an embedment, wherein a second side of the first covering layer is opposite to the first core wire and the second core wire is a heat conductor.

In an embedment, wherein a third side of the second covering layer is conducting toward the bare metal wire.

In an embedment, a third side of the second covering layer toward the bare metal wire is a heat conductor.

In an embedment, the fourth side of the second covering layer opposite the bare metal wire is insulated.

In an embedment, the material of the first covering layer is selected from a heat-insulating material.

According to the embodiments mentioned above, the bare metal wire is arranged inside the wire placement space between the first and second covering layers. The arrangement of the bare metal wire will prevent the bare metal wire from directly transferring heat to the first core wire or the second core wire during welding, and the risk of damaging the insulation layer of the first core wire or the second core wire will be decreased. The core wire set of the disclosure will prevent welding failure due to improper welding parameters during welding. Furthermore, when the diameter of the core wire set is decreased, universal or low-level welding equipment can still be used to conduct welding, thereby reducing the requirement for welding equipment and the difficulty of welding.

### BRIEF DESCRIPTION OF THE DRAWINGS

The accompanying drawings are presented to aid in describing various aspects of the disclosure and are provided solely to illustrate the aspects. To simplify the drawings and highlight the contents to be presented in the drawings, the well-known structures or elements in the drawings may be drawn in a simple schematic manner or presented in an omitted manner. For example, the number of components may be singular or plural. These drawings are provided only to explain these aspects and not to limit thereof.

FIG. 1 is a cross-sectional view of a core wire set according to an embodiment of the disclosure.

FIG. 2 is a side view of a core wire set according to an embodiment of the disclosure.

FIG. 3 and FIG. 4 are structural schematic diagrams of a first covering layer according to an embodiment of the disclosure.

FIG. 5 is a structural schematic diagram of a second covering layer according to an embodiment of the disclosure.

FIG. 6 is a cross-sectional view of a transmission cable according to an embodiment of the disclosure.

### DETAILED DESCRIPTION OF THE PREFERRED EMBODIMENTS

Even though terms such as “first,” “second,” and “third” may be used to describe an element, a part, a region, a layer, and/or a portion in the present specification, these elements, parts, regions, layers and/or portions are not limited by such terms. Such terms are used to differentiate an element, a part, a region, a layer, and/or a portion from another element, part, region, layer, and/or portion. Therefore, in the following discussions, a first element, portion, region, or portion may be called a second element, portion, region, layer, or portion, and do not depart from the teaching of the present disclosure. The terms “comprise,” “include,” or “have” used in the current specification are open-ended terms and mean to “include,” but not limited to

As used herein, the term “coupled to” in the various tenses of the verb “coupled” may mean that element A is directly connected to element B or that other elements may be connected between elements A and B (i.e., that element A is indirectly connected with element B).

The terms “approximate,” or “essentially” used in the present specification include the value itself and the average values within the acceptable range of deviation of the specific values confirmed by a person having ordinary skill in the current art, considering the particular measurement discussed and the number of errors related to such measurement (that is, the limitation of the measurement system). For example, “about” may mean within one or more standard deviations of the value itself or ±30%, ±20%, ±10%, ±5%. In addition, “about,” “approximate,” or “essentially” used in the present specification may select a more acceptable range of deviation or standard deviation based on optical property, etching property, or other properties. One cannot apply one standard deviation to all properties.

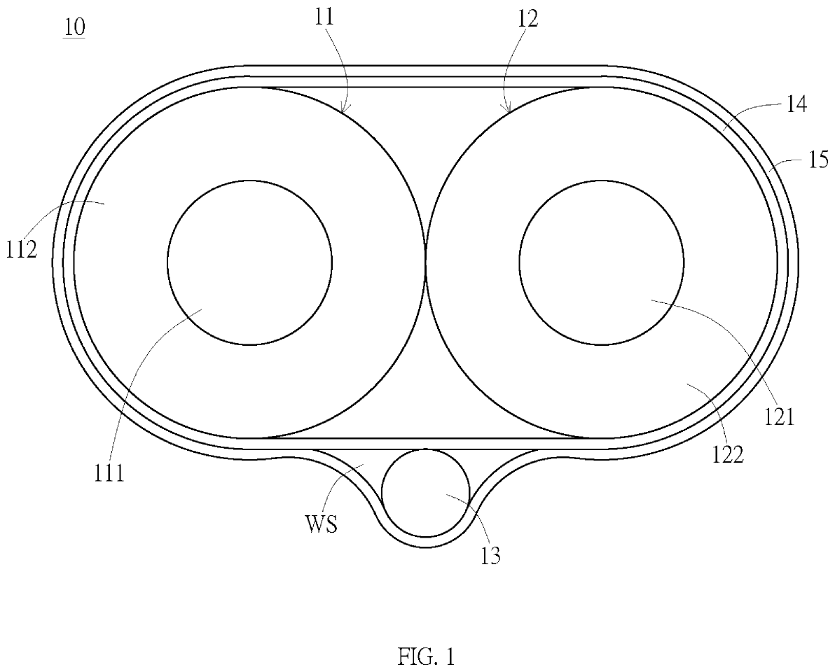

Refer to FIG. 1. FIG. 1 illustrates the core wire set 10 of the disclosure comprises the first core wire 11, the core wire 12 in parallel to the first core wire 11, the first covering layer 14 covering the first core wire 11, and the second core wire 12, the second covering layer 15, and the bare metal wire 13. The second covering layer 15 covers the first covering layer 14 and forms the wire placement space WS with the first covering layer 14. The bare metal wire 13 is arranged inside the wire placement space WS and in parallel with the first core wire 11 and the second core wire 12.

Specifically, the first core wire 11 has the first conductive core 111, and the first insulation layer 112 covers the first conductive core 111. The second core wire 12 has the second conductive core 121, and the second insulation layer 122 covers the second conductive core 121. It should be noted that the cross sections of the first conductive core 111 and the second conductive core 121, shown in FIG. 1, illustrate the embodiment instead of limiting the embodiment. For example, the first core wire 11 and the second core wire 12 may be an electric transmission wire having a single core, multiple cores, or a stranded core. In addition, the embodiment of the disclosure does not require the specifications of the first core wire 11 and the second core wire 12 to be the same. More specifically, the first core wire 11 and the second core wire 12 may have the same or different wire diameters, colors, or compositions (for example, the first core wire 11 may be a single core wire while the second core wire 12 may be a multi-core wire).

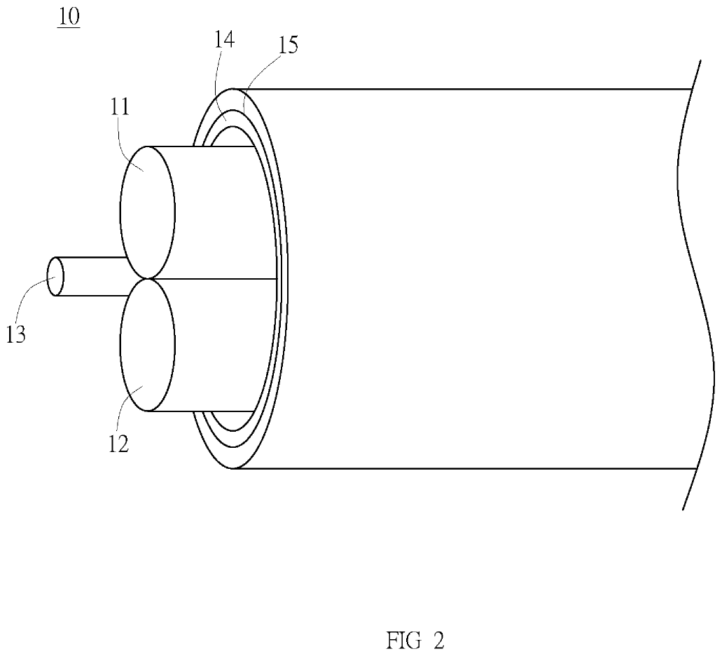

The material of the bare metal wire 13 may be materials with good electrical conductivity, such as copper, aluminum, or silver. When the bare metal wire 13 is used as a drain wire, the exemplary function of a drain wire is to eliminate and/or drain the interference signals between the first core wire 11 and the second core wire 12, or the interference signals externally coupled to the first core wire 11 and/or the second core wire 12. Referring to FIG. 2, FIG. 2 illustrates the side view of the core wire set 10. The first core wire 11, the second core wire 12, and the bare metal wire 13 are set parallelly and extend along the length direction of the core wire set 10. In other words, from the cross-sectional view of the core wire set 10 (as shown in FIG. 1), the center of the first core wire 11, the center of the second core wire 12, and the center of the bare metal wire 13 are arranged in the shape of a triangular. It should be noted that the relative positions of the centers of the first core wire 11, the second core wire 12, and the bare metal wire 13 in core wire set 10 are not constant. For example, the bare metal wire 13 may be wrapped around the first covering layer 14. Therefore, in the cross-sectional view of the core wire set 10, the center of the bare metal wire 13 may have, but is not limited to, an elliptical trajectory around the center of the first core wire 11 and the center of the second core wire 12.

The material of the first covering layer 14 that separates the bare metal wire 13 and covers the first core wire 11 and the second core wire 12 may be selected according to electrical and thermal characteristics. Regarding the aspect of electrical characteristics, the base material (substrate) of the first covering layer 14 may be electrical insulating materials. For example, the first covering layer 14 may be formed by an insulating and stretchable substrate such as PET film (Mylar). Regarding the aspect of thermal conductivity characteristics, the base material (substrate) of the first covering layer 14 may be a material with thermal insulation and soft extensibility, such as insulating textiles and polyimide films. It should be noted that the above examples are not mutually exclusive. The base material (substrate) of the first covering layer 14 may be selected based on careful consideration of other parameters/characteristics such as electrical insulation, heat insulation, the material's hardness, or the material's extensibility. By separating the first covering layer 14 from the bare metal wire 13 and covering the first core wire 11 and the second core wire 12, it is possible to avoid direct heat transfer from the bare metal wire 13 to the first core wire 11 and/or the second core wire 12 during the welding process, which may cause damage to the first insulation layer 112 and/or the second insulation layer 122 and result in shorting between the first conductive core 111 of the first core wire 11 and the second conductive core 121 of the second core wire 12.

Referring to FIG. 3 and FIG. 4, in an embodiment, the first thin conductive layer 142 may be arranged on the first side 1401 (the side of the first covering layer 14 toward the first core wire 11 and the second core wire 12) and/or the second side 1402 (the side of the first covering layer 14 opposite to the first core wire 11 and the second core wire 12) and electrically coupled to a node with the same voltage level (for example, but not limited to ground) with the drain wire. The methods for arranging the first thin conductive layer may be electroplating, steaming, or adhesion. For example, the first thin conductive layer 142 (such as an aluminum foil) can be attached to either side of the substrate 141 of the first covering layer 14 to provide conductivity. As shown in FIG. 3, in the example where the first covering layer 14 is conductive on both sides, the conductive area with the same potential (voltage level) as the drain wire may be increased. The conductive area with the same potential (voltage level) as the drain wire may greatly improve the function of the drain wire. In other words, the function of the bare metal wire 13 as a drain wire can be improved, and the first covering layer 14 can also serve as shielding protection for the first core wire 11 and the second core wire 12 to reduce the noise coupled from outside the core wire set 10. As shown in FIG. 4, in the example where the first covering layer 14 is conductive only on one side, it is preferred that the second side 1402 is conductive so that when the first insulation layer 112 and/or the second insulation layer 122 is/are shrunk during the welding process, the first core wire 11 and the second core wire 12 will not be shorted by the first side 1401 (in the case, the first side 1401 is insulated) of the first covering layer 14, hence significantly reducing the required accuracy control for welding.

The second covering layer 15 covers the first covering layer 14 and the bare metal wire 13, and the wire placement space WS is formed between the first covering layer 14 and the second covering layer 15 to accommodate the bare metal wire 13. More specifically, the bare metal wire 13 can be wrapped around the first covering layer 14, and the second covering layer 15 may directly cover the first covering layer 14 and the bare metal wire wrapped around the outside of the first covering layer 14. Like the first covering layer 14, the materials for the second covering layer 15 can be chosen based on electrical or thermal characteristics. From the aspect of electrical characteristics, for example, the substrate of the second covering layer 15 may be an electrically insulating material. More specifically, the second covering layer 15 may be an insulating and stretchable substrate such as PET film. From the aspect of thermal characteristics, the second covering layer 15 may be a material with thermal insulation and extensibility, such as insulating textiles and polyimide films. It should be noted that the above examples are not mutually exclusive, but can be selected based on a comprehensive consideration of other parameters/characteristics such as electrical insulation, heat insulation, hardness of material, or extensibility of material. In addition, the same or different substrates/materials may be used for the second covering layer 15 and the first covering layer 14. By wrapping the bare metal wire 13 and the first covering layer 14 with the second covering layer 15, the bare metal wire 13 can be less likely to be displaced, and the core wire set 10 can be sturdier, thereby avoiding issues such as the core wire set 10 shorting with other wires after the core wire set 10 and other wires or wire sets are assembled into a transmission cable.

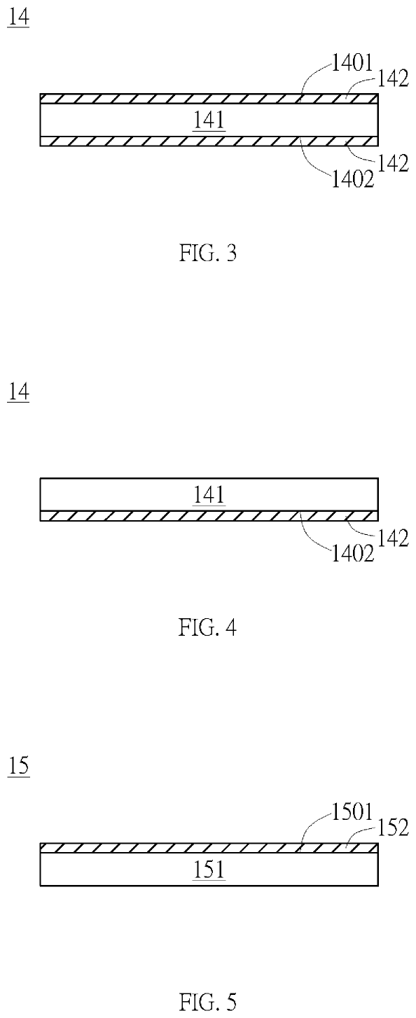

Refer to FIG. 5. In an embodiment, the second conductive layer 152 coupled to the same potential as the drain wire can be arranged on the third side 1501 (facing the first covering layer 14 and the bare metal wire 13) of the substrate 151 of the second covering layer 15. In this way, the conductive area for draining noise or interference can be significantly increased, and the effect of using the bare metal wire 13 as the drain wire can be improved. The second thin conductive layer 152 arranged on the second covering layer 15 can also be used to shield the first core wire 11 and the second core wire 12 to shield coupling noise outside the core wire set 10. On the other hand, the fourth side (opposite to the third side 1501) of the second covering layer 15 is insulated, thereby reducing issues such as the core wire set 10 shorting with other wires after the core wire set 10 and other wires or wire sets are assembled into a transmission cable.

By using the wire placement space WS formed by the first covering layer 14 and the second covering layer 15 to arrange the bare metal wire 13, it is possible to prevent the bare metal wire 13 from directly transferring heat to the first core wire 11 or the second core wire 12 during welding. Thereby, damage to the insulation layer of the first core wire 11 or the second core wire 12 during welding can be avoided. With the core wire set 10, it is possible to reduce welding failure due to the influence of welding parameters during welding. When the wire diameter decreases, universal or low-level welding equipment can still be used to conduct welding, reducing the requirement for welding equipment and the difficulty of welding.

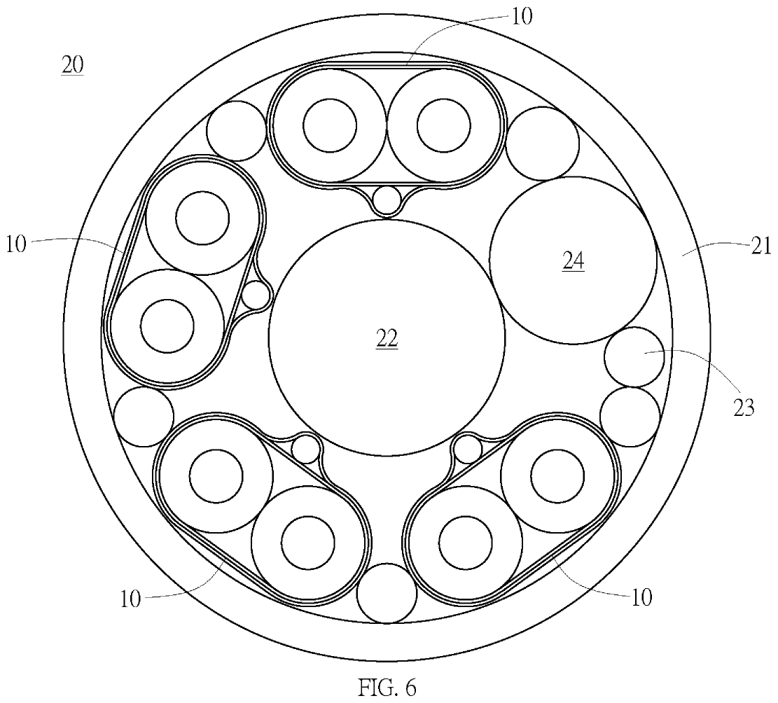

Refer to FIG. 6. FIG. 6 is a cross-sectional view of the transmission cable 20 of the disclosure. The transmission cable 20 includes an outer insulation layer and at least one set of core wires 10. Specifically, the interior of the transmission cable 20 has filler 22 at the center of transmission cable 20, other filler wires 23, at least one set of core wires 10, and other wires 24. The filler 22, the filler wires 23, the wires 24, and the core wires 10 are wrapped by the outer insulation layer 21. It should be noted that although the cross-section of the transmission cable 20 shown in FIG. 6 is circular, FIG. 6 is only for illustration purposes and is not intended to limit this invention. Any transmission cable made by a person having ordinary skill in the art of this field and comprising of the core wire set 10 according to this disclosure should belong to the scope of the disclosure.

The transmission cable 20 of the disclosure has the core wire set 10 with double-covering layers. The double-covering layers can prevent the core wires inside the core wire set 10 from failing due to improper welding settings. When the wire diameter of the transmission cable 20 is reduced, universal or low-level welding equipment can still be used to conduct welding, thereby reducing the requirement for welding equipment and the difficulty of welding.

The foregoing disclosure is merely preferred embodiments of the present invention and is not intended to limit the claims of the present invention. Any equivalent technical variation of the description and drawings of the present invention of the present shall be within the scope of the claims of the present invention.

What is claimed is:

1. A core wire set comprising:
a first core wire;
a second core wire arranged parallel to the first core wire;
a first covering layer covering the first core wire and the second core wire;
a second covering layer covering the first covering layer, wherein a wire placement space is formed between the first covering layer and the second covering layer, and
a bare metal wire arranged in the wire placement space.

2. The core wire set of claim 1, wherein from the cross-section of the core wire set, the center of the first core wire, the center of the second core wire, and the center of the bare metal are arranged in a triangular shape.

3. The core wire set of claim 1, wherein the first side of the first covering layer faces the first core wire and the second core wire is insulated.

4. The core wire set of claim 1, wherein a second side of the first covering layer opposite to the first core wire and the second core wire is conducting.

5. The core wire set of claim 1, wherein a second side of the first covering layer opposite to the first core wire and the second core wire is heat conductor.

6. The core wire set of claim 1, wherein a third side of the second covering layer toward the bare metal wire is conducting.

7. The core wire set of claim 1, wherein a third side of the second covering layer toward the bare metal wire is a heat conductor.

8. The core wire set of claim 1, wherein a fourth side of the second covering layer opposite to the bare metal wire is insulated.

9. The core wire set of claim 1, wherein the material of the first covering layer is selected from heat-insulating material.

10. A transmission cable comprising:
a core wire set containing:
a first core wire;
a second core wire arranged parallel to the first core wire;
a first covering layer covering the first core wire and the second core wire;
a second covering layer covering the first covering layer; wherein a wire placement space is formed between the first covering layer and the second covering layer; and
a bare metal wire arranged in the wire placement space; and
an outer insulation layer covered the core wire set.

11. The transmission cable of claim 10, wherein from the cross-section of the core wire set, the center of the first core wire, the center of the second core wire, and the center of the bare metal are triangular.

12. The transmission cable of claim 10, wherein the first covering layer's first side faces the first core wire and the second core wire is insulated.

13. The transmission cable of claim 10, wherein a second side of the first covering layer is conducted opposite the first core wire and the second core wire.

14. The transmission cable of claim 10, wherein a second side of the first covering layer is opposite to the first core wire, and the second core wire is a heat conductor.

15. The transmission cable of claim 10, wherein a third side of the second covering layer is conducting toward the bare metal wire.

16. The transmission cable of claim 10, wherein a third side of the second covering layer toward to the bare metal wire is heat conductor.

17. The transmission cable of claim 10, wherein a fourth side of the second covering layer opposite to the bare metal wire is insulated.

18. transmission cable of claim 10, wherein the material of the first covering layer is selected from heat insulating material.
